(19) United States
(12) Patent Application Publication
(10) Pub. No.: US 2020/0083790 A1
(43) Pub. Date: Mar. 12, 2020

(54) ELECTROMAGNETIC ACTUATOR FOR A MECHANICAL FEEDBACK UNIT

(71) Applicant: BEHR-HELLA THERMOCONTROL GMBH, Stuttgart (DE)

(72) Inventor: Winfried FUST, Lippstadt (DE)

(21) Appl. No.: 16/491,724

(22) PCT Filed: Mar. 9, 2018
(86) PCT No.: PCT/EP2018/055885

§ 371 Date: Sep. 6, 2019

(30) Foreign Application Priority Data
Mar. 9, 2017 (DE) 10 2017 105 045.0

(51) Int. Cl. H02K 33/18

(52) U.S. Cl. CPC H02K 33/18; B60K 37/06

(57) ABSTRACT

The electromagnetic actuator (10) as an actuator of a mechanical feedback unit of a control device for a vehicle component is provided with a stator (12) and a translator (24), which can be moved in translation along a movement axis (36) and which, whilst maintaining a distance to the stator (12), can be moved back and forth between a rest position and at least one end position and preferably one of two end positions, which, relative to the rest position, are arranged in opposite directions along the movement axis (36) starting from the rest position. The actuator (10) further comprises a guidance arrangement (40) for guiding the translator (24) in translation while its moving, wherein the guidance arrangement (40) has at least one leaf spring (38), which extends transversely to the movement axis (36) and has a central attachment portion (46) and a fixing portion (42) on either side of the attachment portion (46). Either the translator (24) is mechanically coupled with the attachment portion (46) of the leaf spring (38) and the fixing portions (42) thereof are mechanically coupled to the stator (12), or the stator (12) is mechanically coupled to the attachment portion (46) of the leaf spring (38) and the fixing portions (42) thereof are mechanically coupled to the translator (24).

The invention relates to an electromagnetic actuator as an actuator of a mechanical feedback unit of an operating device for a vehicle component. The invention further relates to an operating device for a vehicle component with such an electromagnetic actuator as an actuator of a mechanical feedback unit of the operating device.

Modern operating concepts, in particular for vehicle component operating devices, comprise an operating element with an operating surface, which is designed as a touchscreen on which touch fields are displayed. A command is entered by touching a touch field, wherein the person receives tactile feedback and confirmation on a valid operating input. The tactile feedback is provided by a brief mechanical excitation of the operating element, for which, inter alia, electromagnetic actuators are used.

Such an electromagnetic actuator should have an actuator that is guided as accurately as possible.

In general, an electromagnetic actuator comprises a stator and a translator that can be moved in translation relative to the stator along a movement axis. The translator is arranged between parts of the stator relative to which it should maintain a constant distance during its translatory movement. For this purpose, the electromagnetic actuator normally comprises a guidance arrangement for guiding the translator in translation while its moving.

The guidance arrangement occasionally also takes over the function of returning the translator into its rest position. Such an electromagnetic actuator in the form of an immersion-coil actuator is described in DE-A-10 2015 220 494. However, the mechanical guidance by means of leaf springs used in this example does not ensure that a distance between the translator and the stator is constantly maintained for larger translatory movements.

From JP-A-2017-018958 a vibration actuator is known, with which a weight can be moved back and forth within a frame when being electromagnetically driven. For this purpose, the weight is spring-elastically mounted by means of leaf springs at its ends located in the oscillation axis.

In EP-A-3 070 578 and EP-A-1 939 061 vibration actuators for operating units are described.

It is an object of the invention to provide an electromagnetic actuator with improved guidance as an actuator of a mechanical feedback unit of an operating device for a vehicle component.

The object of the invention is achieved by providing an electromagnetic actuator, comprising
a stator
a translator which can be moved in translation along a movement axis and which, whilst maintaining a distance to the stator, can be moved back and forth between a rest position and at least one end position and preferably one of two end positions, which, relative to the rest position, are arranged in opposite directions along the movement axis starting from the rest position, and
a guidance arrangement for guiding the translator in translation while its moving,
wherein the guidance arrangement comprises at least one leaf spring which extends transversely to the movement axis and has a central attachment portion and a fixing portion on either side of the attachment portion, and
wherein either the translator is mechanically coupled with the attachment portion of the leaf spring and the fixing portions thereof are mechanically coupled with the stator, or the stator is mechanically coupled with the attachment portion of the leaf spring and the fixing portions thereof are mechanically coupled with the translator.

The electromagnetic actuator according to the invention comprises a stator and a translator that can be moved in translation along a movement axis. The translator can be moved linearly along the movement axis but also along a curved line. It is decisive that the translator can be moved in translation. As the translator moves, the distance between the translator and the stator remains the same. The translator can be moved back and forth between a rest position and at least one end position. Preferably, the translator can be moved from its rest position in two opposite directions to an end position from which it is then moved back to the rest position.

For the translatory guidance of the translator during its movement, a guidance arrangement is provided according to the invention, which comprises at least one leaf spring extending transversely to the movement axis. The leaf spring comprises a central attachment portion and a fixing portion on either side of the attachment portion, wherein the two fixing portions are preferably provided at the opposite ends of the leaf spring. According to the invention, the two fixing portions are mechanically coupled with the stator and the attachment portion is mechanically coupled with the translator. Alternatively, according to the invention, the two fixing portions of the leaf spring are mechanically coupled with the translator and the attachment portion of the leaf spring is mechanically coupled to the stator.

This arrangement of the leaf spring, whose two ends are connected either to the stator or to the translator, results in a precise parallel guidance of the translator relative to the stator. This guidance can be improved by the fact that the guidance arrangement comprises two leaf springs extending transversely to the movement axis of the translator, each having a central attachment portion and two fixing portions arranged on either side of the attachment portion, and that the two leaf springs—viewed in the direction of the movement axis of the translator—are arranged at a distance from one another and, in particular, at opposite ends of either the translator or the stator. The arrangement of the translator and the stator between or at the two leaf springs ensures an exact parallel guidance of the translator and the stator, respectively, without the latter being exposed to torques during its movement (in particular when the translator and/or stator and the leaf spring or leaf springs are symmetrical with respect to the movement axis). Thus, additional mechanical guidance elements are not required. The translator is mechanically fixed exclusively to the two leaf springs, which ensure that the distance to the stator does not change when the translator moves and that the translator is not subjected to any torques. The advantage of using the at least one leaf spring in its alignment according to the invention, transverse to the movement axis of the translator and transverse to the alignment of the air gap between the translator and the stator, i.e. transverse to the air gap between the translator and the stator itself, is that the guidance of the translator transverse to the air gap between the translator and the stator is ideally stiff in order to avoid contact with the stator and thus friction and noise. The translator is softly coupled to the stator in the movement direction of the translator. By means of the guidance arrangement in accordance with the invention comprising the at least one leaf spring arranged in accordance with the invention, which is positioned in such a way that the plane it spans is directed transversely to the air gap, it is possible to provide electromagnetic actuators whose air gaps, i.e. whose distances between the translator and the stator are minimal, so that compact, small-volume constructions can be implemented.

In a further expedient embodiment of the invention, it can be provided that the attachment portion of the at least one leaf spring comprises an attachment lug protruding from the attachment portion, wherein leaf spring is attached to the translator—or alternatively to the stator—by means of the attachment lug, and that each fixing portion of the at least one leaf spring is provided with a protruding fixing lug, wherein the leaf spring is mounted to the stator—or alternatively to the translator—by means of the fixing lug.

The electromagnetic actuator according to the invention can preferably be implemented as a so-called immersion-coil actuator where the translator is adapted as a plate-like translator element (translator plate element) which is arranged between two plate-like stator elements (stator plate elements) of the stator. The two stator plate elements are kept at a distance from each other by means of mechanical spacers. The translator plate element, which is coupled by means of at least one leaf spring, preferably by means of two leaf springs, to one of the stator plate elements or respectively to one of the stator plate elements, is disposed in the space between the two stator plate elements. In the case of two leaf springs, both can be arranged between the translator and one of the stator plate elements; alternatively, one leaf spring can be arranged between the translator plate element and one of the stator plate elements and the other leaf spring can be arranged between the translator plate element and the other stator plate element. Since the translator is guided in accordance with the invention by entirely parallel displacement of the translator plate element relative to the stator plate elements and without an impact of torques on the translator plate element, the previously described structure of the electromagnetic actuator can be implemented with minimal air gaps between the translator plate element and the two stator plate elements.

In a further expedient embodiment of the invention, it can be provided that either the stator comprises at least one permanent magnet and/or at least one stator coil and the translator comprises at least one translator coil cooperating with the permanent magnet of the stator and/or the stator coil for the purpose of a linear movement of the translator, or the translator comprises at least one permanent magnet and/or at least one translator coil and the stator comprises at least one stator coil cooperating with the permanent magnet of the translator and/or the translator coil for the purpose of a linear movement of the translator, and that a control unit for controlling the at least one stator coil and/or the at least one translator coil is provided.

According to the invention, the above-mentioned object is also achieved by means of an operating device for a vehicle component, wherein said operating device comprises
a housing,
a manually operable operating element arranged in and/or at the housing and having an operating surface,
wherein the operating element is laterally movable and/or movable along a movement axis comprising a lateral component, and
an electromagnetic actuator according to any one of the aforementioned variants, which can be activated for the tactile confirmation of a manual operation of the operating surface of the operating element,
wherein the stator of the actuator is mechanically coupled with the housing and the translator of the actuator is mechanically coupled with the operating element, or the stator of the actuator is mechanically coupled with the operating element and the translator of the actuator is mechanically coupled with the housing.

In the following, the invention is described in more detail with reference to the drawing, in which:

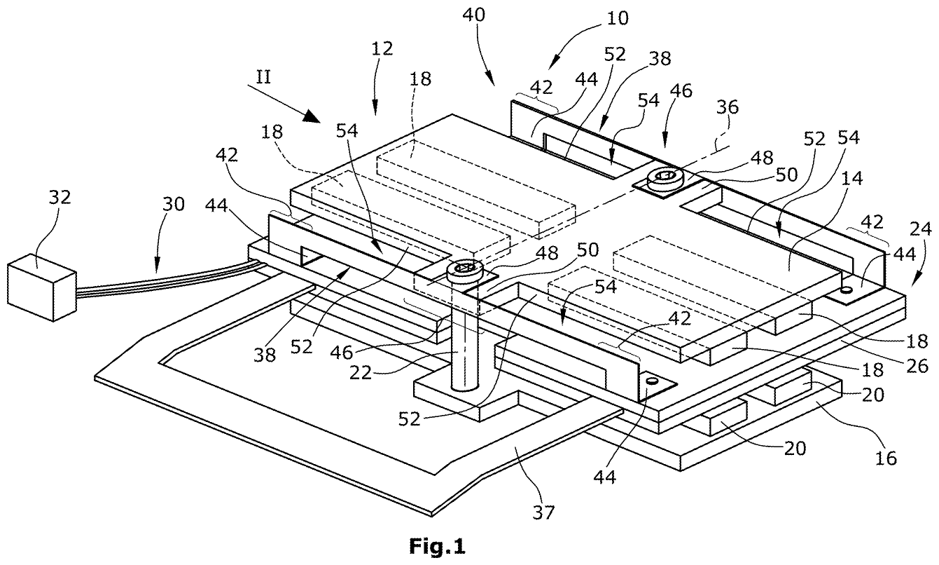

FIG. 1 is a perspective view showing an exemplary embodiment of an electro-magnetic actuator according to the invention, comprising two leaf springs extending transversely to the movement axis of the translator,

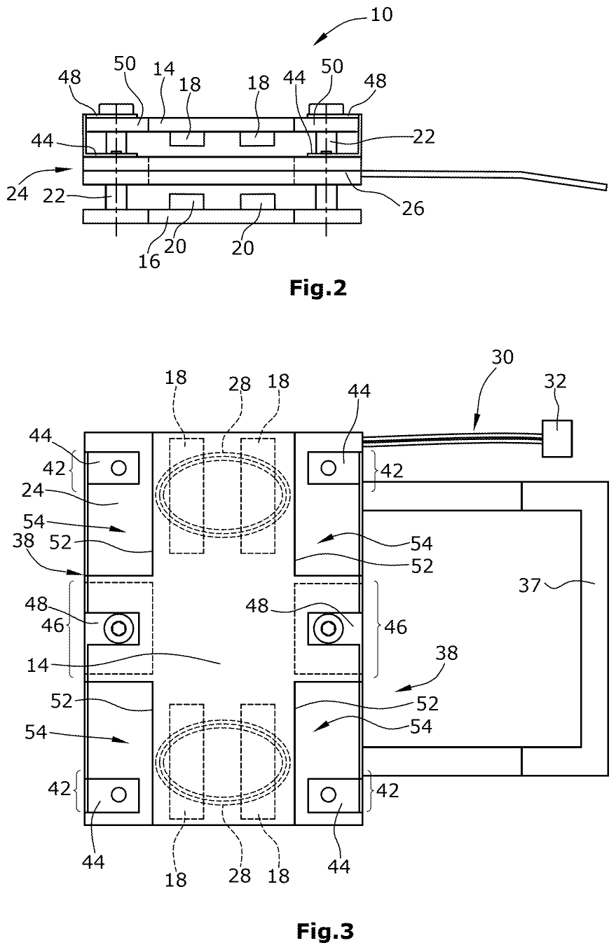

FIG. 2 is a side view showing the electromagnetic actuator according to FIG. 1,

FIG. 3 is a plan view showing the electromagnetic actuator according to FIG. 1,

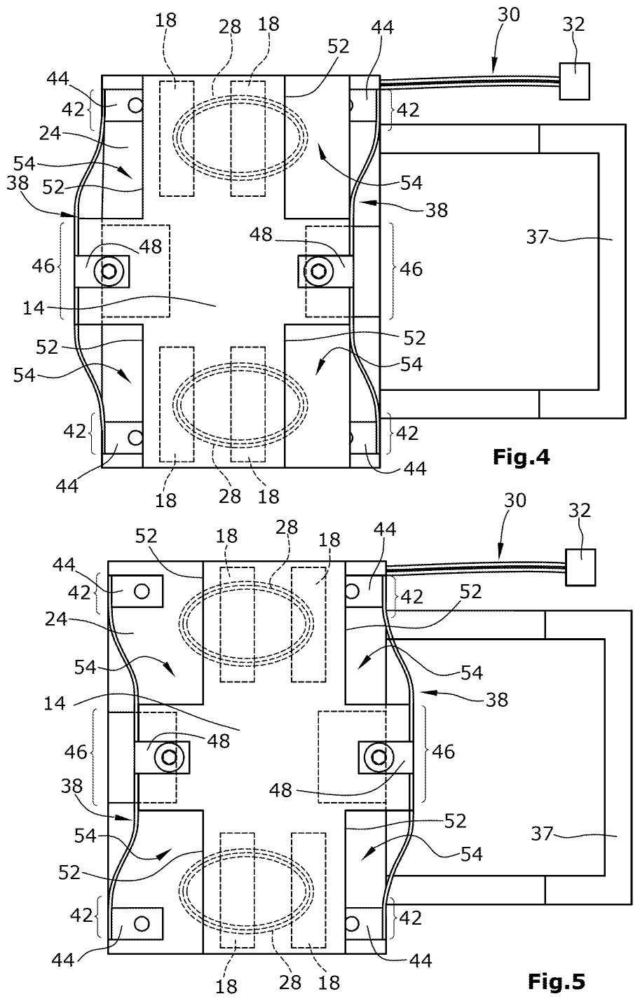

FIGS. 4 and 5

are a plan view showing the electromagnetic actuator after being activated to move the translator from its rest position into one of the two possible end positions respectively,

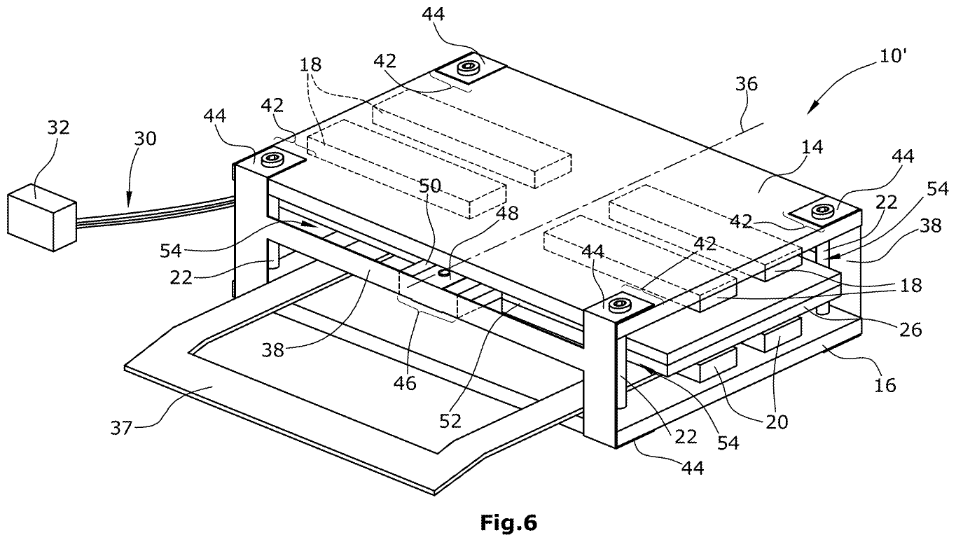

FIG. 6 is a perspective view showing an alternative exemplary embodiment of an electromagnetic actuator comprising two leaf springs extending transversely to the movement axis of the translator according to the invention, and

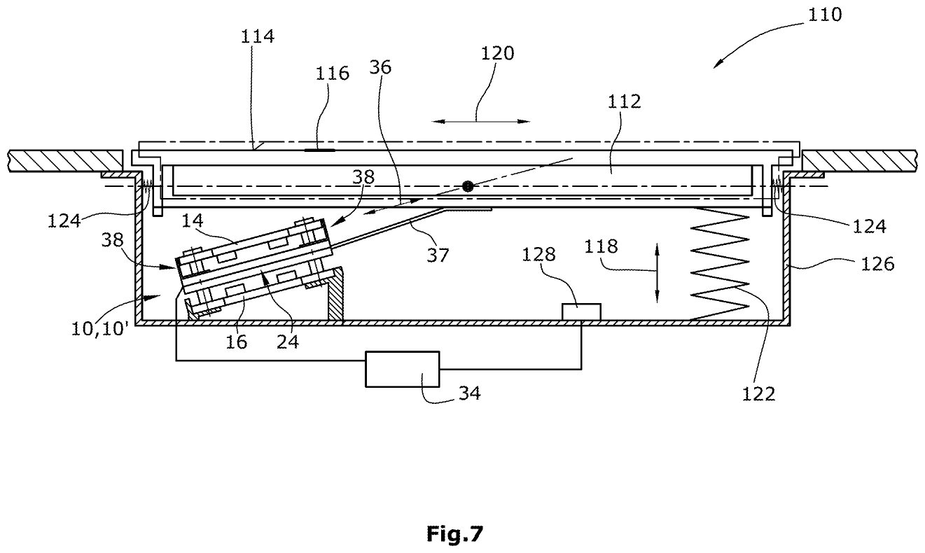

FIG. 7. schematically shows the structure of an operating device for a vehicle component, wherein an operating element of the operating device is mechanically excited by means of the electromagnetic actuator according to FIGS. 1 to 5 in order to provide a tactile feedback and thus a confirmation of an operator input.

FIG. 1 is a perspective view showing an electromagnetic actuator 10 according to an exemplary embodiment of the invention, wherein FIGS. 2 and 3 are a side view and a plan view, respectively, showing the electromagnetic actuator. Actuator 10 comprises a stator 12 which, in this exemplary embodiment, comprises two spaced stator plate elements 14,16 arranged one above the other. Said stator plate elements 14,16 are provided with permanent magnets 18, 20. Two bolt-shaped spacers 22 connect the two stator plate elements 14,16 to each other.

A translator 24, which is adapted is this exemplary embodiment as a translator plate element 26, is arranged between two stator plate elements 14,16. Translator plate element 26 is provided with at least one electric coil 28. An electric line 30 leads to translator 24, which, for example, can be electrically connected to a control unit 34 by means of a plug indicated with reference numeral 32. By controlling coil 28, translator 24 moves, depending on the direction of the flow, in one of two opposite directions. The movement axis, along which translator 24 moves, is indicated in FIG. 1 with reference numeral 36 (see e.g. FIG. 6).

A coupling element 37 is connected to translator 24 and implements the mechanical connection between translator 24 and an object to be moved by translator 24, for example a spring-elastically mounted operating element of a vehicle operating device (see e.g. FIG. 6).

According to the invention, translator 24 is softly coupled with one of the two stator plate elements 14,16 in the direction of extension of movement axis 36 and is stiffly coupled transversely thereto. The stiff coupling ensures that translator 24 cannot move towards the direction of stator 12 when moving along movement axis 36. Thus, the air gap above and below translator 24 relative to the stator plate elements 14,16 remains unchanged when translator 24 moves. This stiff coupling also prevents the actuator gap from changing under a load transverse to movement axis 36.

This special mechanical coupling of translator 24 with, in this exemplary embodiment, upper stator plate element 14 is achieved by two leaf springs 38 which ensure a guidance arrangement 40 for the translatory guidance of translator 24 while maintaining the air gap relative to the stator plate elements 14,16. Each leaf spring 38 comprises at its two ends respectively one fixing portion 42, each of which is provided with an angled fixing lug 44 protruding laterally from the corresponding end of the leaf spring 38. Between the to fixing portions 42 of each leaf spring 38 an attachment portion 46 is provided which is centered between the ends of the corresponding leaf spring 38. The attachment lugs 48 protrude from each of the attachment portions 46. In this exemplary embodiment, the attachment lugs 48 are mounted to the upper stator plate element 14 while the fixing lugs 44 are mounted to translator 24. The upper stator plate element 14 comprises, in the area of the attachment portions 46 of the leaf springs 38, protruding attachment projections 50, which are aligned opposite to each other, to which the attachment lugs 48 are mounted. Due to this attachment projections 50, a space 54 relative to each adjacent leaf spring 38 is formed between each of the (front and rear) ends 53 of stator plate element 14 located along movement axis 36, so that translator 24 can now be moved along movement axis 36 in both directions by a specific path without that the fixing portions 42 of the leaf springs 38 taken along by translator 24 collide with the upper stator plate element 14. This situation is illustrated in FIGS. 4 and 5.

FIG. 6 shows the structure of actuator 10′, which represents an alternative embodiment, wherein the elements constructively and functionally corresponding to those of actuator 10 in FIGS. 1 to 5 are denoted by the same reference numerals.

In contrast to actuator 10 according to FIGS. 1 to 5, the leaf springs 38 of actuator 10′ in FIG. 6 are mounted in the corresponding attachment portion 46 to an attachment projection 50 of translator 24 and are connected at the fixing portions 42 to both stator plate elements 14, 16. Thus, the leaf springs 38 also function as spacers for the stator plate elements 14,16; however, separate spacers 22 can also be provided, as shown dashed in FIG. 6.

In the following, a possibility of using the electromagnetic actuator for an operating device for a vehicle component with force feedback functionality is described with reference to FIG. 1.

FIG. 7 is a side view and schematically shows an operating device 110 comprising an operating element 112. In this exemplary embodiment, operating element 112 is configured as a display assembly with an operating surface 114 on which a plurality of symbol fields can be displayed. Operating element 112 is normally backlit.

To carry out an actuating movement in the vertical movement direction (see double arrow 118) and to confirm such an actuation movement in the lateral direction (see double arrow 120 in FIG. 7), the operating element 112 is elastically mounted to a housing 126 via schematically indicated first and second springs 122, 124. A sensor 128 can be used to determine that operating element 112 has moved along the vertical movement axis 118. This is determined in the evaluation and control unit 34, whereupon said evaluation and control unit controls actuator 10 (or 10′). The fixed stator 12 of actuator 10 (or 10′) is supported on housing 126, while translator 24 is mechanically coupled with operating element 112 by means of coupling element 37 (or vice versa). The active movement axis of translator 24 is illustrated by double arrow 36.

The larger and more complex operating element 112 is constructed, the heavier it is, and the more installation space is takes up. If it is now requested that the haptic feedback should be that same over the entire operating surface 114, then operating element 112 should only perform a translatory movement during haptic feedback. The linear guidance of translator 24 contributes to this.

According to FIG. 7, the entirely translatory movement of operating element 112 during active haptic feedback comprises both a lateral and a vertical component. The fact that this feedback movement is not entirely lateral plays no role in the fact that the haptic sensation should be the same across the entire operating surface 114 of operating element 112. It is decisive that operating element 112 does not undergo any rotatory movement proportion during active haptic feed-back, which means that operating element 112 is advantageously exclusively parallelly displaced in space, which is also supported by the linear guidance of translator 24.

The above-described arrangement of actuator 10 (or 10′) in operating unit 110 of FIG. 6 is not necessarily required for the invention but provides certain advantages with regard to haptic feedback, which is also described in the PCT application PCT/EP2017/051416, the content of which is hereby incorporated by reference into the present patent application.

### LIST OF REFERENCE NUMERALS

10 actuator
10′ actuator
12 stator
14 upper stator plate element
16 lower stator plate element
18 permanent magnet
20 permanent magnet
22 spacer
24 translator
26 translator plate element
28 coil
30 line
32 plug
34 control unit
36 movement axis of translator
37 coupling element
38 leaf springs
40 guidance arrangement for leaf springs
42 fixing portion
44 fixing lug
46 attachment portion
48 attachment lug
50 attachment projection
52 ends of each stator plate element located in extension of movement axis
54 space between a stator plate element end and adjacent leaf springs
110 operating unit
112 operating element
114 operating surface
116 symbol field
118 vertical movement axis
120 double arrow
122 springs
124 springs
126 housing
128 sensor

1. Electromagnetic actuator for a mechanical feedback unit of an operating device, particularly provided for a vehicle component, for a tactile feedback of an operation of the operating device, comprising
a stator,
a translator which can be moved in translation along a movement axis and which can be moved back and forth be-tween a rest position and at least one end position, whilst maintaining an air gap distance, directed orthogonally to the movement axis, to the stator, and
a guidance arrangement for guiding the translator in translation while its moving,
wherein the guidance arrangement comprises at least one leaf spring which extends transversely to the movement axis and to the alignment of the air gap distance of stator and translator and has a central attachment portion and a fixing portion on either side of the attachment portion, and
wherein either the translator is mechanically coupled with the attachment portion of the leaf spring and the fixing portions thereof are mechanically coupled with the stator, or the stator is mechanically coupled with the attachment portion of the leaf spring and the fixing portions thereof are mechanically coupled with the translator.

2. Electromagnetic actuator according to claim 1, wherein the translator, whilst maintaining an air gap distance, directed orthogonally to the movement axis, to the stator, can be moved back and forth between a rest position and one of two end position, which, relative to the rest position, are arranged in opposite directions along the movement axis starting from the rest position.

3. Electromagnetic actuator according to claim 1, wherein the attachment portion of the at least one leaf spring comprises an attachment lug protruding from the attachment portion, wherein the leaf spring is attached to the translator by means of the attachment lug, and in that each fixing portion of the at least one leaf spring is provided with a protruding fixing lug, wherein the leaf spring is mounted to the stator by means of the fixing lug.

4. Electromagnetic actuator according to claim 1, wherein the attachment portion of the at least one leaf spring comprises an attachment lug protruding from the attachment portion, wherein the leaf spring is attached to the stator by means of the attachment lug, and in that each fixing portion of the at least one leaf spring is provided with a protruding fixing lug, wherein the leaf spring is mounted to the translator by means of the fixing lug .

5. Electromagnetic actuator according to claim 1, wherein the guidance arrangement comprises two leaf springs extending transversely to the movement axis of the translator, each having a central attachment portion and two fixing portions arranged on either side of the attachment portion, and in that the two leaf springs, viewed in the direction of the movement axis of the translator, are arranged at a distance from one another and, in particular, at opposite ends of either the translator or the stator.

6. Electromagnetic actuator according to claim 1, wherein the stator comprises two plate-like stator elements, and in that the translator is adapted as a plate-like translator element arranged between the stator elements.

7. Electromagnetic actuator according to claim 1, wherein either the stator comprises at least one permanent magnet and/or at least one stator coil and the translator comprises at least one translator coil cooperating with the permanent magnet of the stator and/or the stator coil for the purpose of a linear movement of the translator, or the translator comprises at least one permanent magnet and/or at least one translator coil and the stator comprises at least one stator coil cooperating with the permanent magnet of the translator and/or the translator coil for the purpose of a linear movement of the translator, and in that a control unit for controlling the at least one stator coil and/or the at least one translator coil is provided.

8. Operating device for a vehicle component, comprising
a housing 420,
a manually operable operating element arranged in and/or at the housing and having an operating surface,
wherein the operating element is laterally movable and/or movable along a movement axis comprising a lateral component, and
an electromagnetic actuator according to any one of the pre-ceding claims, which can be activated for the tactile confirmation of a manual operation of the operating surface of the operating element,
wherein the stator of the actuator is mechanically coupled with the housing and the translator of the actuator is mechanically coupled with the operating element, or the stator of the actuator is mechanically coupled with the operating element and the translator of the actuator is mechanically coupled with the housing.
